(19) United States
(12) Patent Application Publication
(10) Pub. No.: US 2017/0277159 A1
(43) Pub. Date: Sep. 28, 2017

(54) REMOTE CONTROL DEVICE

(71) Applicant: Beijing Xiaomi Mobile Software Co., Ltd., Beijing (CN)

(72) Inventors: DONGXU LIU, Beijing (CN); Yi Wang, Beijing (CN); Qiaoyu Chen, Beijing (CN)

(73) Assignee: Beijing Xiaomi Mobile Software Co., Ltd.

(21) Appl. No.: 15/460,343

(22) Filed: Mar. 16, 2017

(30) Foreign Application Priority Data
Mar. 24, 2016 (CN) 201610173310.2

(51) Int. Cl. G05B 19/10; G08C 17/02; G08C 21/00; G08C 17/06

(52) U.S. Cl. CPC G05B 19/106; G08C 17/06; G08C 17/02; G08C 21/00; G05B 2219/2639; G08C 2201/10

(57) ABSTRACT

A remote control device includes: a housing; a central processor arranged in the housing and configured to control operations of the remote control device; a thermoelectric generator arranged in the housing and coupled to the central processor; a button module arranged in the housing and coupled to the central processor and the thermoelectric generator; and a communication module coupled to the central processor and the thermoelectric generator, wherein: the thermoelectric generator includes an electricity generator having two metal sheets made of different materials, the two metal sheets being connected to each other at two connection points and forming a closed loop circuit via the two connection points, and the electricity generator is configured to generate a thermoelectromotive force based on a temperature difference between the two connection points, and power the central processor, the button module, and the communication module using the thermoelectromotive force.

### CROSS-REFERENCE TO RELATED APPLICATION

This application is based on and claims priority to Chinese Patent Application No. 201610173310.2, filed on Mar. 24, 2016, the entire content of which is incorporated herein by reference.

### FIELD

The present disclosure generally relates to wireless remote control and, more particularly, to a remote control device.

### BACKGROUND

Nowadays, appliances, such as televisions, air conditioners, and stereos, are usually provided with remote control devices from the manufacturers. The remote control devices can be used to control the appliances over a short distance.

Existing remote control devices are often powered by dry-cell batteries. Since electric energy stored in a dry-cell battery is limited, a user needs to replace the dry-cell battery periodically, resulting in a waste of resources. Moreover, dry-cell batteries contain heavy metals, such as mercury, manganese, cadmium, and lead. When the outer case of a dry-cell battery corrodes, these heavy metals gradually enter into the soil and groundwater, leading to environmental pollution. Therefore, in order to save resources and protect environment, a new remote control device is needed.

### SUMMARY

According to one aspect of the present disclosure, there is provided a remote control device, comprising: a housing; a central processor arranged in the housing and configured to control operations of the remote control device; a thermoelectric generator arranged in the housing and coupled to the central processor; a button module arranged in the housing and coupled to the central processor and the thermoelectric generator; and a communication module coupled to the central processor and the thermoelectric generator, wherein: the thermoelectric generator includes an electricity generator having two metal sheets made of different materials, the two metal sheets being connected to each other at two connection points and forming a closed loop circuit via the two connection points, and the electricity generator is configured to generate a thermoelectromotive force based on a temperature difference between the two connection points, and power the central processor, the button module, and the communication module using the thermoelectromotive force.

It is to be understood that both the forgoing general description and the following detailed description are exemplary and interpretative only, and are not restrictive of the present disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a schematic structural diagram showing a remote control device according to an exemplary embodiment.

FIG. 2 is a schematic structural diagram showing a thermoelectric generator according to an exemplary embodiment.

FIG. 3 is a schematic structural diagram showing an electricity generator according to an exemplary embodiment.

FIG. 4 is a schematic structural diagram showing a thermoelectric generator according to an exemplary embodiment.

FIG. 5 is a schematic structural diagram showing a remote control device according to an exemplary embodiment.

FIG. 6 is a schematic structural diagram showing a remote control device according to an exemplary embodiment.

FIG. 7 is a schematic structural diagram showing a remote control device according to an exemplary embodiment.

### DETAILED DESCRIPTION

Reference will now be made in detail to exemplary embodiments, examples of which are illustrated in the accompanying drawings. The following description refers to the accompanying drawings in which same reference numbers in different drawings represent same or similar elements unless otherwise described. The implementations set forth in the following description of exemplary embodiments do not represent all implementations consistent with the disclosure. Instead, they are merely examples of devices and methods consistent with aspects related to the disclosure as recited in the appended claims.

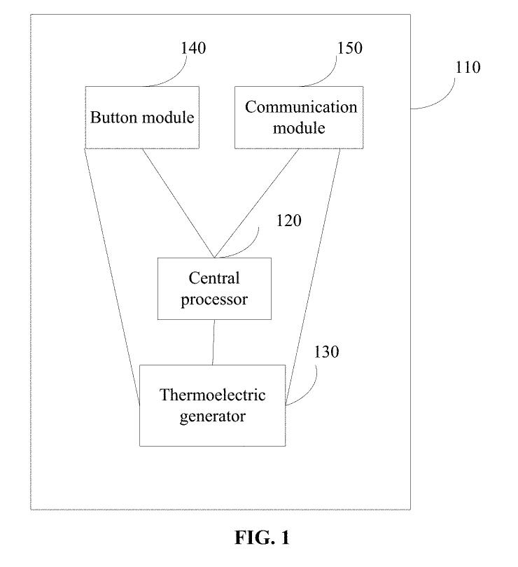

In order to solve the problems of resource waste and environmental pollution caused by the external power supply (such as a dry-cell battery) for existing remote control devices, a remote control device is provided according to the disclosure. The remote control device is based on the Seebeck effect, including a closed loop circuit formed by connecting two different types of metals. When the temperatures at two connection points of the closed loop circuit are different, a thermoelectromotive force is generated. The remote control device can be powered based on the thermoelectromotive force. FIG. 1 schematically shows an exemplary remote control device 100 consistent with the disclosure. As shown in FIG. 1, the remote control device 100 includes a housing 110. The remote control device 100 further includes a central processor 120, a thermoelectric generator 130, a button module 140, and a communication module 150 arranged in the housing 110.

The thermoelectric generator 130 is coupled to each of the central processor 120, the button module 140, and the communication module 150. The thermoelectric generator 130 supplies electric power to the remote control device 100. The central processor 120 is coupled to the button module 140 and the communication module 150. The central processor 120 controls operations of each functional module of the remote control device 100. The button module 140 detects user operations on buttons of the remote control device 100, also referred to hereinafter as “push-button operations,” and sends the detected push-button operations to the central processor 120. The communication module 150 transmits instructions generated by the central processor 120 based on the push-button operations to an appliance paired with the remote control device 100.

According to the disclosure, the button module 140 can include a plurality of buttons. Each of the buttons corresponds to a function of the remote control device 100 for controlling the appliance paired with the remote control device 100, also referred to herein as the “paired appliance,” to perform an operation. For example, if the paired appliance is an intelligent speaker, the button module 140 of the remote control device 110 can include, e.g., a “switch button,” a “state transition button,” and a “volume adjustment button.” The “switch button” controls the intelligent speaker to be turned on or off. The “state transition button” controls the intelligent speaker to change its state. The “volume adjustment button” controls the intelligent speaker to adjust its volume.

In some embodiments, the communication module 150 can be one of a Bluetooth module, a Wireless Fidelity (WiFi) module, an infrared module, or a Near Field Communication (NFC) module. Upon reception of an instruction sent by the central processor 120, the communication module 150 transmits the instruction to the paired appliance in the form of a Bluetooth signal, a WiFi signal, or an infrared signal, or via an NFC data channel established with the paired appliance, depending on the type of the communication module 150.

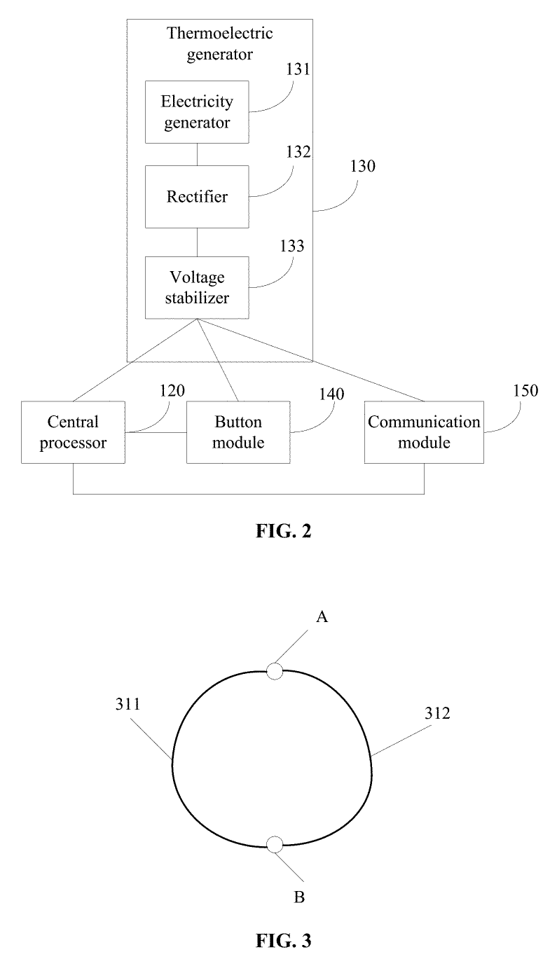

Referring to FIG. 2, the thermoelectric generator 130 includes an electricity generator 131, a rectifier 132, and a voltage stabilizer 133. Referring to FIG. 3, the electricity generator 131 includes two metal sheets 311 and 312 made of different materials. The metal sheet 311 and metal sheet 312 are connected end to end to form a first connection point A and a second connection point B. The first connection point A is positioned within a holding area of the remote control device 100, while the second connection point B is positioned out of the holding area. The holding area refers to an area on the remote control device 100 that is designed to be held by a user. The metal sheet 311 and the metal sheet 312 form a closed loop circuit via the first connection point A and the second connection point B. When the user holds the remote control device 100, the temperature at the first connection point A becomes higher than the temperature at the second connection point B. When there is a temperature difference between the first connection point A and the second connection point B, the electricity generator 131 generates a thermoelectromotive force, which powers the central processor 120, the button module 140, and the communication module 150 coupled to the thermoelectric generator 130.

In some embodiments, the two metal sheets 311 and 312 in the electricity generator 131 are made of titanium alloys. For example, one of the metal sheets 311 and 312 can be made of the alloy of titanium and a first metal, and the other one of the metal sheets 311 and 312 can be made of the alloy of titanium and a second metal different from the first metal. In some embodiments, the two metal sheets 311 and 312 in the electricity generator 131 are made of aluminum alloys. For example, one of the metal sheets 311 and 312 can be made of the alloy of aluminum and a third metal, and the other one of the metal sheets 311 and 312 can be made of the alloy of aluminum and a fourth metal different from the third metal. The first and third metals may or may not be different. Similarly, the second and fourth metals may or may not be different.

Operating principles of the remote control device 100 are described below.

When a user uses the remote control device 100 to control a paired appliance, the user holds the remote control device 100, for example, at the holding area. Thus, the temperature at the first connection point A within the holding area increases and becomes higher than the temperature at the second connection point B. As a result, a thermoelectromotive force is generated between the first connection point A and the second connection point B, which then powers the central processor 120, the button module 140, and the communication module 150. When the button module 140 detects a push-button operation of the user pressing a button of the remote control device 100, the button module 140 sends a signal indicating the detected push-button operation to the central processor 120. According to the button pressed by the user, the central processor 120 generates a corresponding control command, and sends the control command to the communication module 150. The communication module 150 transmits the control command to the paired appliance, to control the paired appliance.

Sometimes, the electric energy generated by the thermoelectric generator 130 may not be stable. Referring again to FIG. 2, in some embodiments, to achieve steady direct current (DC) electricity, the thermoelectric generator 130 further includes a rectifier 132 and a voltage stabilizer 133. The rectifier 132 is coupled to the electricity generator 131. One end of the voltage stabilizer 133 is coupled to the rectifier 132, and the other end of the voltage stabilizer 133 is coupled to each of the central processor 120, the button module 140, and the communication module 150. The rectifier 132 rectifies the output of the electricity generator 131. The voltage stabilizer 133 stabilizes the rectified output. The voltage stabilizer 133 can be provided as, for example, a stabilivolt device.

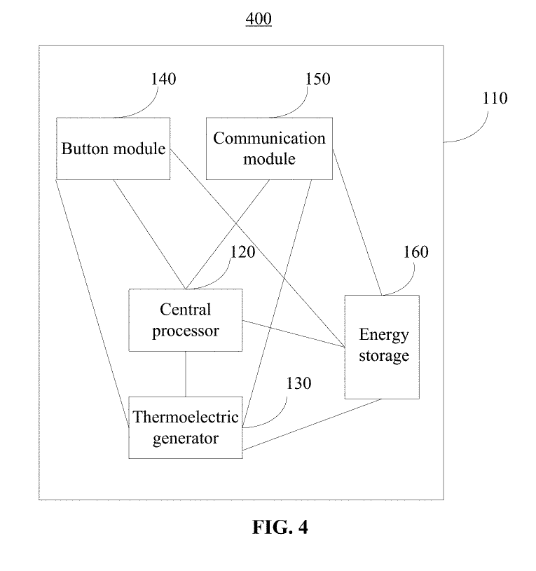

FIG. 4 schematically shows another exemplary remote control device 400 consistent with the disclosure. The remote control device 400 is similar to the remote control device 100, except that the remote control device 400 further includes an energy storage 160 coupled to the thermoelectric generator 130, the central processor 120, the button module 140, and the communication module 150. The energy storage 160 can be a storage capacitor with a large capacity. When the user holds the remote control device 400, the thermoelectric generator 130 initially generates a relatively large thermoelectromotive force. A portion of the thermoelectromotive force can be used to supply electric power to other functional modules, and the remaining portion of the thermoelectromotive force can be stored in the energy storage 160. With the passage of time, the thermoelectromotive force generated by the thermoelectric generator 130 gradually becomes smaller as the temperature difference between the first connection point A and the second connection point B becomes smaller. When the temperature at the first connection point A approximately equals the temperature at the second connection point B, the thermoelectric generator 130 stops generating electric energy, and then the remote control device 110 can be powered by the energy storage 160.

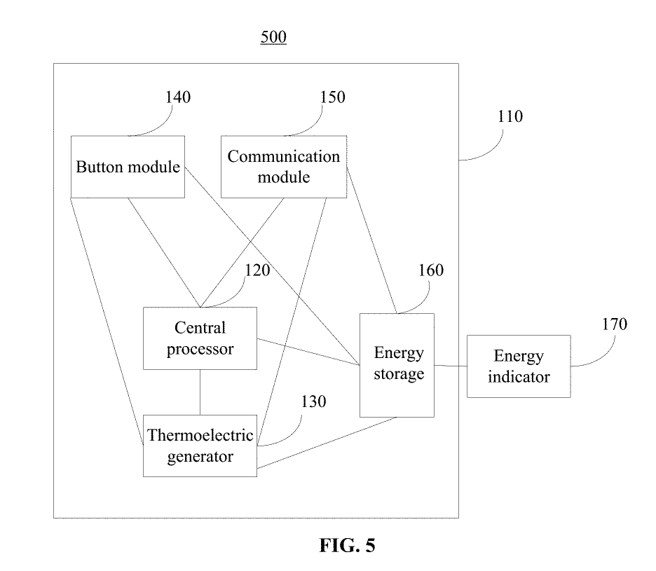

FIG. 5 schematically shows another exemplary remote control device 500 consistent with the disclosure. The remote control device 500 is similar to the remote control device 400, except that the remote control device 500 further includes an energy indicator 170 coupled to the energy storage 160. The energy indicator 170 can be, for example, an indication light, and has two states: on and off. When there is no electric energy stored in the energy storage 160, the energy indicator 170 is off. On the other hand, when there is electric energy stored in the energy storage 160, the energy indicator 170 is on.

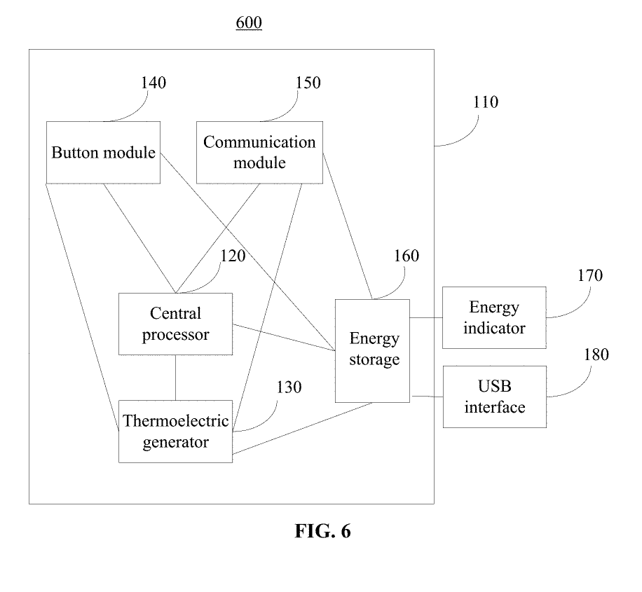

FIG. 6 schematically shows another exemplary remote control device 600 consistent with the disclosure. The remote control device 600 is similar to the remote control device 500, except that, the remote control device 600 further includes a Universal Serial Bus (USB) interface 180 coupled to the energy storage 160. The USB interface 180 can couple the energy storage 160 to a power supply to charge the energy storage 160.

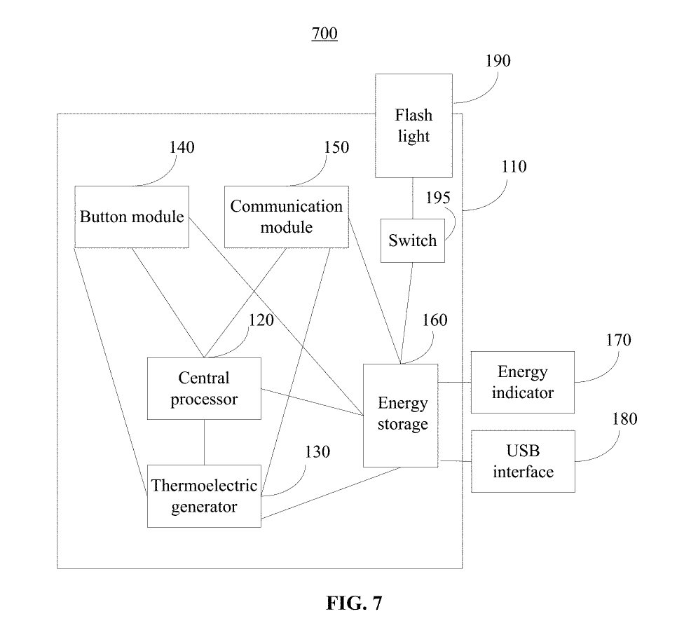

FIG. 7 schematically shows another exemplary remote control device 700 consistent with the disclosure. The remote control device 700 is similar to the remote control device 600, except that, the remote control device 700 further includes a flashlight 190 and a switch 195. The flashlight 190 is used for lighting. The flashlight 190 is coupled to the switch 195, which is in turn coupled to the energy storage 160. To allow the user to easily observe the state of the switch 195, the switch 195 includes two states: “on” state and “off” state. When the user holds the remote control device 700 and switches the switch 195 to the on state, the energy storage 160 can power the flashlight 190 to provide lighting for the user.

A remote control device consistent with the disclosure uses a built-in thermoelectric generator to power other functional modules, and thus an external power supply, such as a dry-cell battery, is not needed. As a result, resources can be saved. Further, since the electricity generated in the remote control device is pollution free, environmental pollution can be avoided.

Other embodiments of the disclosure will be apparent to those skilled in the art from consideration of the specification and practice of the disclosure herein. This application is intended to cover any variations, uses, or adaptations of the disclosure following the general principles thereof and including such departures from the present disclosure as come within known or customary practice in the art. It is intended that the specification and embodiments should be considered as exemplary only, with a true scope and spirit of the disclosure being indicated by the following claims.

It will be appreciated that the inventive concept is not limited to the exact construction that has been described above and illustrated in the accompanying drawings, and that various modifications and changes can be made without departing from the scope thereof. It is intended that the scope of the disclosure only is limited by the appended claims.

What is claimed is:

1. A remote control device, comprising:
a housing;
a central processor arranged in the housing and configured to control operations of the remote control device;
a thermoelectric generator arranged in the housing and coupled to the central processor;
a button module arranged in the housing and coupled to the central processor and the thermoelectric generator; and
a communication module coupled to the central processor and the thermoelectric generator,
wherein:
the thermoelectric generator includes an electricity generator having two metal sheets made of different materials, the two metal sheets being connected to each other at two connection points and forming a closed loop circuit via the two connection points, and
the electricity generator is configured to generate a thermoelectromotive force based on a temperature difference between the two connection points, and power the central processor, the button module, and the communication module using the thermoelectromotive force.

2. The remote control device of claim 1, further comprising:
an energy storage coupled to the thermoelectric generator.

3. The remote control device of claim 2, wherein the energy storage includes a storage capacitor.

4. The remote control device of claim 2, further comprising:
an energy indicator coupled to the energy storage and configured to indicate an off state when there is no electric energy stored in the energy storage and an on state when there is electric energy stored in the energy storage.

5. The remote control device of claim 2, further comprising:
a Universal Serial Bus (USB) interface coupled to the energy storage.

6. The remote control device of claim 2, further comprising:
a switch coupled to the energy storage; and
a flashlight coupled to the switch.

7. The remote control device of claim 1, wherein the button module includes a plurality of buttons, each corresponding to a function of the remote control device.

8. The remote control device of claim 1, wherein the thermoelectric generator further includes:
a rectifier coupled to the electricity generator; and
a voltage stabilizer, one end of the voltage stabilizer being coupled to the rectifier, and the other end of the voltage stabilizer being coupled to the central processor, the button module, and the communication module.

9. The remote control device of claim 1, wherein the two metal sheets in the electricity generator are made of titanium alloys or aluminum alloys.

10. The remote control device of claim 1, wherein the communication module includes one of a Bluetooth module, a Wireless Fidelity (WiFi) module, an infrared module, or a Near Field Communication (NFC) module.
